(19) United States
(12) Patent Application Publication
(10) Pub. No.: US 2016/0326750 A1
(43) Pub. Date: Nov. 10, 2016

(54) Floor Tile Structure that can be Used Repeatedly

(71) Applicant: Chi-Jung Lin, Taichung City (TW)

(72) Inventor: Chi-Jung Lin, Taichung City (TW)

(21) Appl. No.: 14/886,137

(22) Filed: Oct. 19, 2015

(30) Foreign Application Priority Data
May 8, 2015 (TW) 104207047

(51) Int. Cl. E04F 15/02; B32B 27/36; B32B 7/12; B32B 27/06; B32B 3/30; B32B 3/06

(52) U.S. Cl. CPC E04F 15/0215; E04F 15/02005; B32B 3/30; B32B 3/06; B32B 7/12; B32B 27/06; B32B 27/36; B32B 2255/10; B32B 2255/26; B32B 2405/00; B32B 2419/04

(57) ABSTRACT

A floor tile structure includes a surface layer, an intermediate layer mounted on a bottom face of the surface layer, and a bottom layer arranged on a bottom face of the intermediate layer and stuck to the surface layer. The intermediate layer includes an adhesive that is applied over the bottom face of the surface layer. The bottom layer includes a film layer attached to the bottom face of the intermediate layer, a reusable sticky layer attached to a bottom face of the film layer and a release paper attached to a bottom face of the reusable sticky layer. The reusable sticky layer can be used and stuck repeatedly. The release paper can be removed from the reusable sticky layer.

### BACKGROUND OF THE INVENTION

1. Field of the Invention

The present invention relates to a tile and, more particularly, to a floor tile structure that can be used repeatedly.

2. Description of the Related Art

A conventional plastic floor tile has a DIY feature and comprises a plastic layer, a decorative layer printed on the top face of the plastic layer, and a glue layer applied on the bottom face of the plastic layer. The glue layer is an inductive thermosol. When the thermosol of the glue layer is pressed at a specific temperature, the thermosol produces a strong bonding force so that the plastic floor tile is stuck to the ground closely. After the plastic floor tile is stuck to the ground, the plastic floor tile is affixed to and cannot be removed from the ground. However, when the plastic floor tile is skew on the ground, the plastic floor tile cannot be detached from the ground so that the user has to break and remove the plastic floor tile by a tool, thereby causing difficulty in the process of construction, and thereby wasting the material of the plastic floor tile. In addition, the plastic floor tile does not have a buffering effect so that when the plastic floor tile is mounted on an uneven ground, the plastic floor tile protrudes upward, thereby easily causing an uncomfortable sensation to a pedestrian when stepping on the plastic floor tile. Further, the plastic floor tile does not have a positioning function so that when multiple plastic floor tiles are paved on the ground, the plastic floor tiles cannot align with each other easily and are easily arranged in a skew manner.

### BRIEF SUMMARY OF THE INVENTION

The primary objective of the present invention is to provide a floor tile structure, wherein when the floor tile structure is paved in a skew manner, the floor tile structure can be repeatedly removed from the ground and then attached to the ground again.

Another objective of the present invention is to provide a floor tile structure, wherein when the floor tile structure is paved on an uneven ground, the floor tile structure has a buffering effect to provide a comfortable sensation to the user when stepping on the floor tile structure.

A further objective of the present invention is to provide a floor tile structure, wherein when multiple floor tile structures are paved on the ground, the floor tile structures are assembled easily and quickly.

In accordance with one embodiment of the present invention, there is provided a floor tile structure comprising a surface layer, an intermediate layer mounted on a bottom face of the surface layer, and a bottom layer arranged on a bottom face of the intermediate layer and stuck to the surface layer. The surface layer is a sheet plate with a determined length and thickness. The surface layer has a top face provided with a pattern zone. The intermediate layer includes an adhesive that is applied over the bottom face of the surface layer. The bottom layer includes a film layer attached to the bottom face of the intermediate layer, a reusable sticky layer attached to a bottom face of the film layer and a release paper attached to a bottom face of the reusable sticky layer. The film layer is made of transparent material and has a profile corresponding to that of the surface layer. The reusable sticky layer can be used and stuck repeatedly and has a profile corresponding to that of the film layer. The release paper is made of transparent material and has a profile corresponding to that of the reusable sticky layer. The release paper can be removed from the reusable sticky layer.

In accordance with another embodiment of the present invention, there is provided a floor tile structure comprising a surface layer, an intermediate layer mounted on a bottom face of the surface layer, a soft layer arranged on a bottom face of the intermediate layer and stuck to the surface layer, and a bottom layer arranged on a bottom face of the soft layer and stuck to the surface layer. The surface layer is a sheet plate with a determined length and thickness. The surface layer has a top face provided with a pattern zone. The intermediate layer includes an adhesive that is applied over the bottom face of the surface layer. The soft layer has ductile and buffering characteristics. The bottom layer includes a film layer attached to the bottom face of the soft layer, a reusable sticky layer attached to a bottom face of the film layer and a release paper attached to a bottom face of the reusable sticky layer. The film layer is made of transparent material and has a profile corresponding to that of the surface layer. The reusable sticky layer can be used and stuck repeatedly and has a profile corresponding to that of the film layer. The release paper is made of transparent material and has a profile corresponding to that of the reusable sticky layer. The release paper can be removed from the reusable sticky layer.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a floor tile structure in accordance with the preferred embodiment of the present invention.

FIG. 2 is an exploded perspective view of the floor tile structure as shown in FIG. 1.

FIG. 3 is a cross-sectional view of the floor tile structure as shown in FIG. 1.

FIG. 4 is a schematic operational view of the floor tile structure as shown in FIG. 3.

FIG. 5 is a cross-sectional view of a floor tile structure in accordance with another preferred embodiment of the present invention.

FIG. 6 is a perspective assembly view of a usage state of the floor tile structure as shown in FIG. 5.

FIG. 7 is an exploded perspective view of a floor tile structure in accordance with the preferred embodiment of the present invention.

FIG. 8 is a cross-sectional assembly view of the floor tile structure as shown in FIG. 7.

FIG. 9 is a schematic operational view of the floor tile structure as shown in FIG. 8.

FIG. 10 is another schematic operational view of the floor tile structure as shown in FIG. 8.

FIG. 11 is a cross-sectional view of a floor tile structure in accordance with another preferred embodiment of the present invention.

FIG. 12 is a perspective assembly view of a usage state of the floor tile structure as shown in FIG. 11.

### DETAILED DESCRIPTION OF THE INVENTION

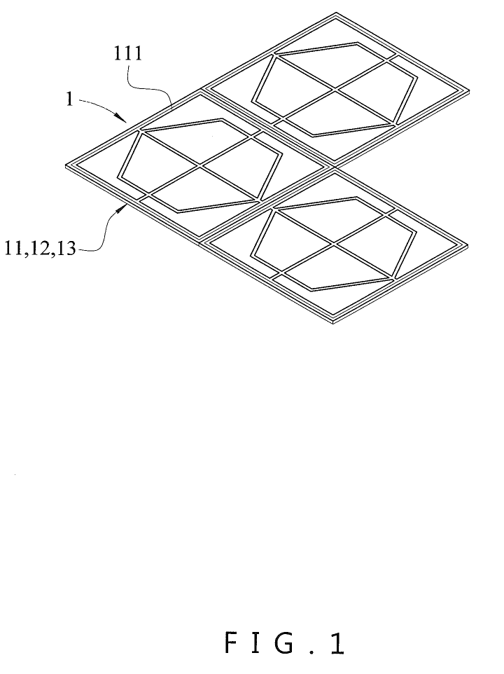

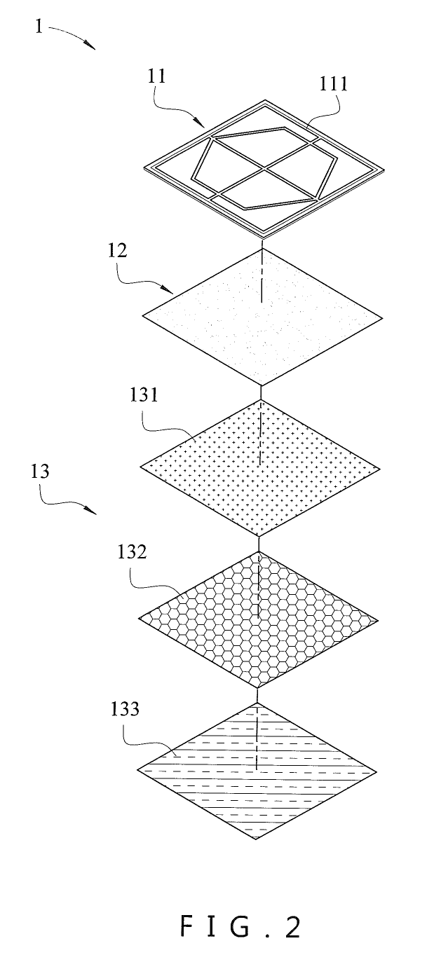

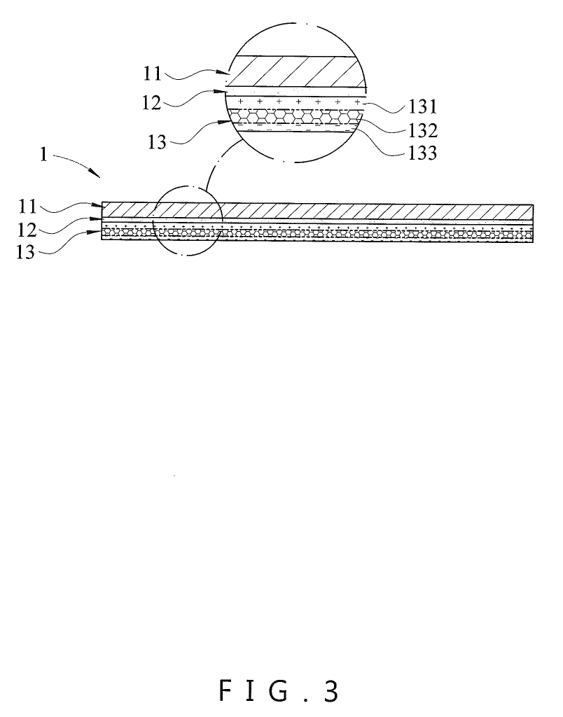

Referring to the drawings and initially to FIGS. 1-4, a floor tile structure 1 in accordance with the preferred embodiment of the present invention comprises a surface layer 11, an intermediate layer 12 mounted on a bottom face of the surface layer 11, and a bottom layer 13 arranged on a bottom face of the intermediate layer 12 and stuck to the surface layer 11.

The surface layer 11 is a sheet plate with a determined length and thickness. The surface layer 11 has a top face provided with a pattern zone 111.

The intermediate layer 12 includes an adhesive that is applied over the bottom face of the surface layer 11.

The bottom layer 13 includes a film layer 131 attached to the bottom face of the intermediate layer 12, a reusable sticky layer 132 attached to a bottom face of the film layer 131, and a release paper 133 attached to a bottom face of the reusable sticky layer 132. The film layer 131 is made of transparent material and has a profile corresponding to that of the surface layer 11. The reusable sticky layer 132 can be used and stuck repeatedly and has a profile corresponding to that of the film layer 131. The release paper 133 is made of transparent material and has a profile corresponding to that of the reusable sticky layer 132. The release paper 133 can be removed from the reusable sticky layer 132.

In the preferred embodiment of the present invention, the pattern zone 111 of the surface layer 11 has a convex or concave shape. Preferably, the pattern zone 111 of the surface layer 11 includes stripes, characters or animal figures. Preferably, the pattern zone 111 of the surface layer 11 is stuck to or transfer printed on the surface layer 11. Preferably, the adhesive of the intermediate layer 12 is selected from a quick-drying glue, an AB glue or a silicone. Preferably, the film layer 131 is made of PET. Preferably, the reusable sticky layer 132 is made of a PU glue.

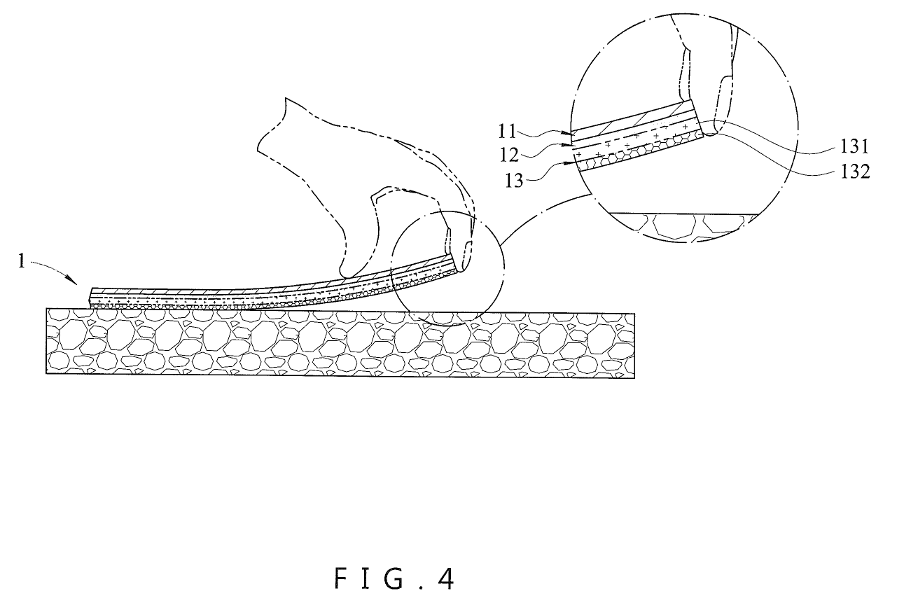

In practice, referring to FIG. 4 with reference to FIGS. 1-3, when the release paper 133 is removed from the reusable sticky layer 132, the reusable sticky layer 132 is stuck to the ground, so that the floor tile structure 1 is attached to the ground by the stable absorption force between the reusable sticky layer 132 and the face of the ground. When the floor tile structure 1 is skew or not located at an exact position of the ground, the reusable sticky layer 132 is removed from the ground, so that the floor tile structure 1 can be attached to the ground again.

Accordingly, the floor tile structure 1 can be removed from and then attached to the ground repeatedly until the floor tile structure 1 is located at the exact position of the ground, thereby facilitating the user mounting the floor tile structure 1 onto the ground. In addition, the reusable sticky layer 132 can be removed from the ground and used repeatedly so that the user can detach the floor tile structure 1 from the ground and attach the floor tile structure 1 to the ground repeatedly without having to break the floor tile structure 1, thereby saving the cost of material. Further, the reusable sticky layer 132 can be removed from the ground so that the user needs not to break and remove the floor tile structure 1 with any tool, thereby facilitating the user operating the floor tile structure 1. Further, the reusable sticky layer 132 is directly removed from the ground without producing any residues on the ground, thereby facilitating the user clearing the ground when the floor tile structure 1 is removed from the ground.

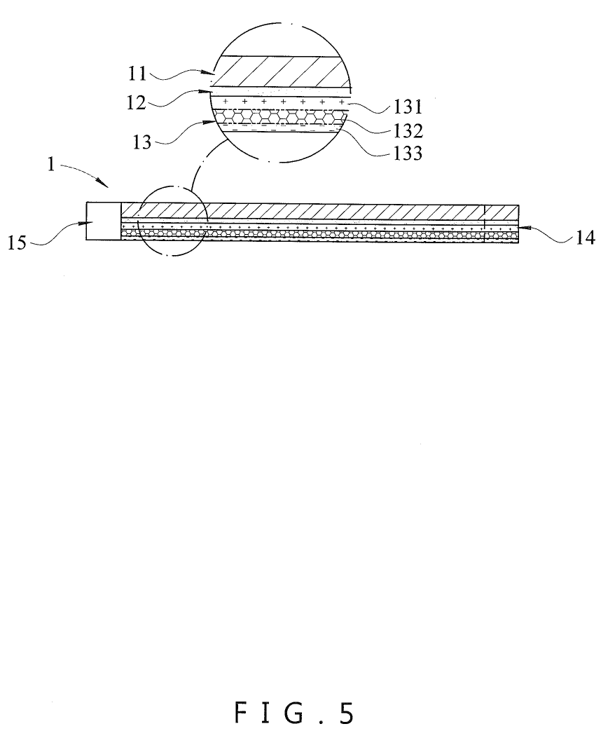

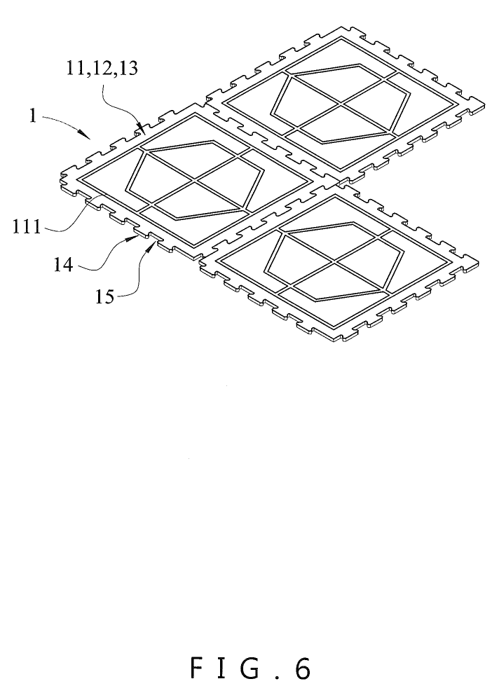

Referring to FIGS. 5 and 6, the floor tile structure 1 has a periphery provided with a plurality of connecting blocks 14 and a plurality of connecting grooves 15. The connecting blocks 14 and the connecting grooves 15 are located at a periphery of the surface layer 11, the intermediate layer 12 and the bottom layer 13. Preferably, the connecting blocks 14 and the connecting grooves 15 present a convex or concave state and are distant equally from each other. Preferably, the connecting blocks 14 and the connecting grooves 15 have geometric profiles matching each other, such as dovetailed, rectangular, arcuate or polygonal shapes. In assembly, multiple floor tile structures 1 are combined together by connection of the connecting blocks 14 and the connecting grooves 15 so that the floor tile structures 1 are assembled easily and quickly. Thus, the floor tile structures 1 are previously combined together and then paved on and stuck to the ground.

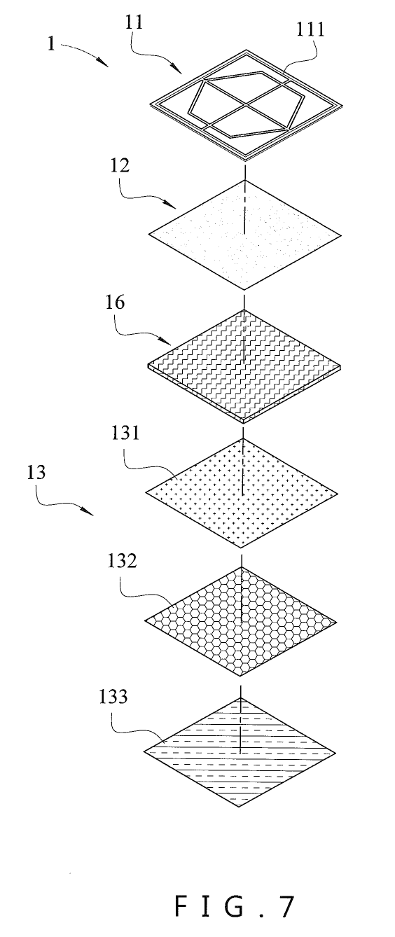

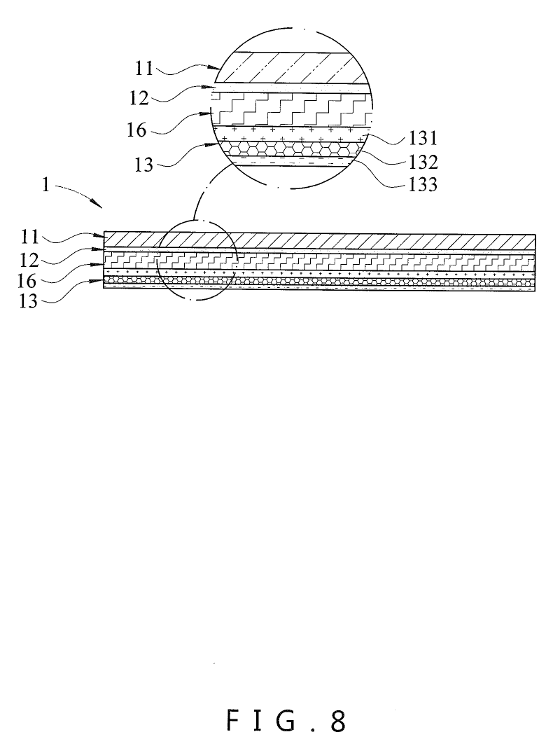

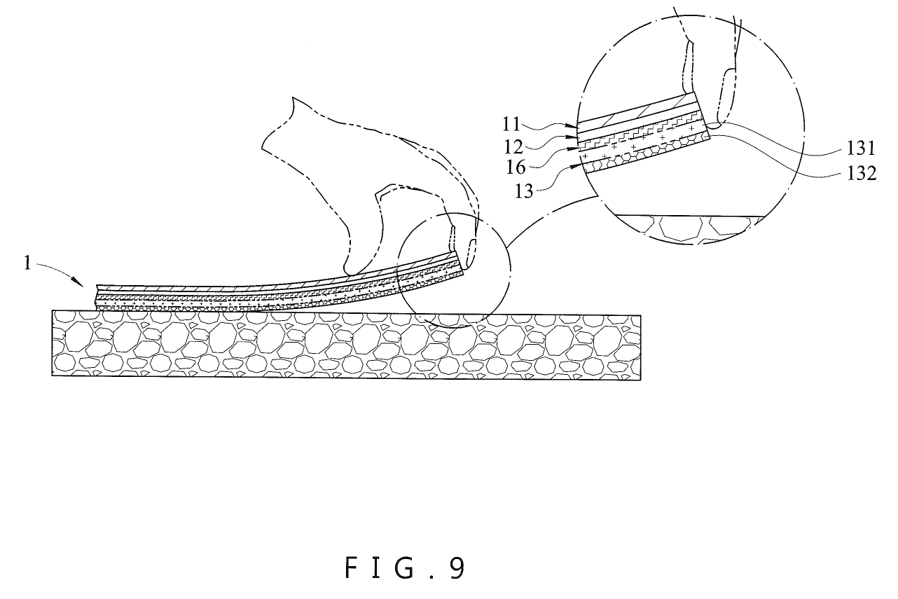

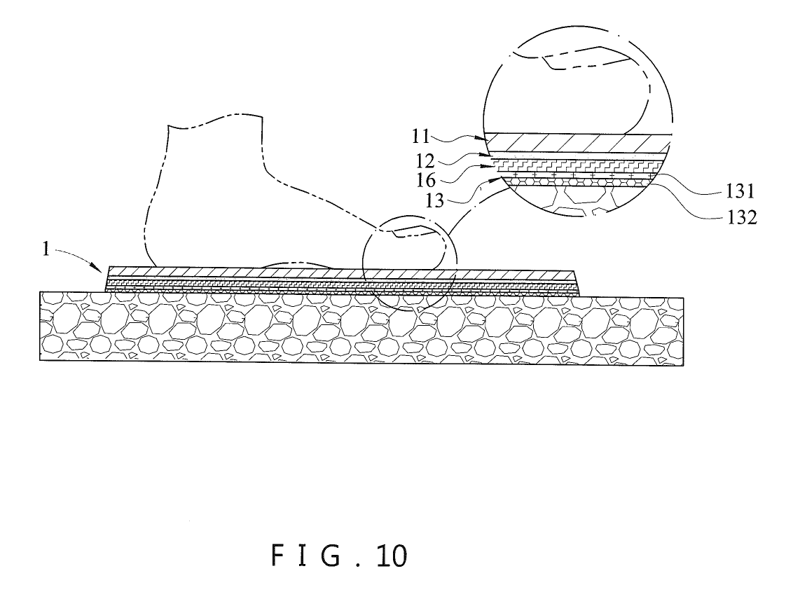

Referring to FIGS. 7-10, the floor tile structure 1 comprises a surface layer 11, an intermediate layer 12 mounted on a bottom face of the surface layer 11, a soft layer 16 arranged on a bottom face of the intermediate layer 12 and stuck to the surface layer 11, and a bottom layer 13 arranged on a bottom face of the soft layer 16 and stuck to the surface layer 11. The features of the surface layer 11, the intermediate layer 12 and the bottom layer 13 are the same as that illustrated in the embodiment as shown in FIGS. 1-4, and will not be further described in detail. The soft layer 16 has ductile and buffering characteristics. Preferably, the soft layer 16 is made of flexible material that is selected from any one of PU, PP or foamable material. The film layer 131 is attached to the bottom face of the soft layer 16. Thus, the soft layer 16 has a buffering effect to provide a comfortable sensation to the user when stepping on the floor tile structure 1 as shown in FIG. 10 even if the ground is uneven or upheaves.

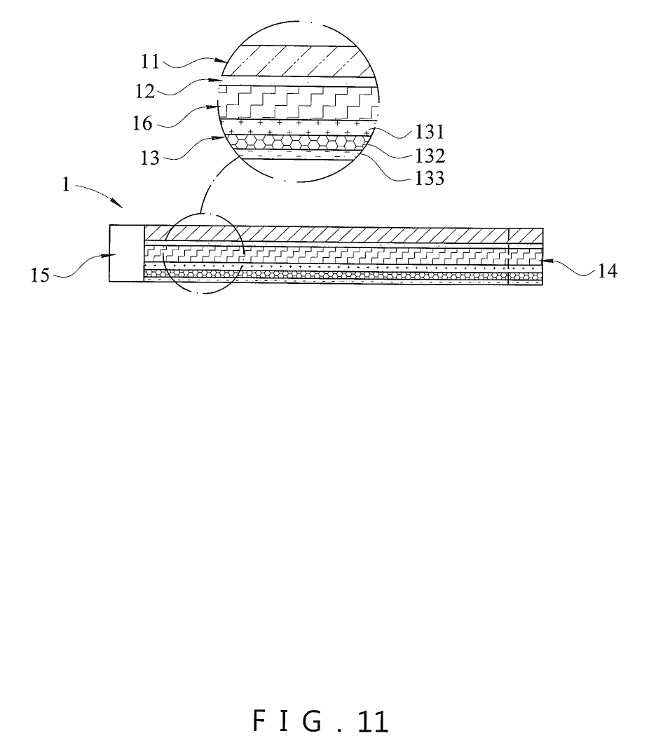

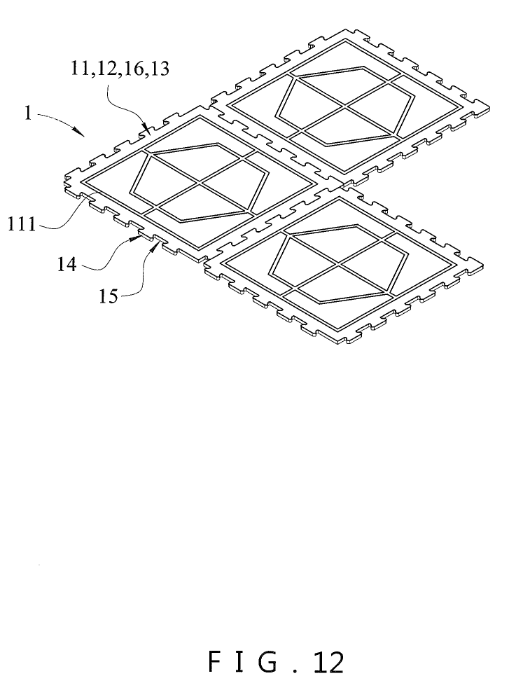

Referring to FIGS. 11 and 12, the floor tile structure 1 has a periphery provided with a plurality of connecting blocks 14 and a plurality of connecting grooves 15. The connecting blocks 14 and the connecting grooves 15 are located at a periphery of the surface layer 11, the intermediate layer 12, the soft layer 16 and the bottom layer 13. The features of the connecting blocks 14 and the connecting grooves 15 are the same as that illustrated in the embodiment as shown in FIGS. 5 and 6, and will not be further described in detail.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A floor tile structure comprising:
a surface layer;
an intermediate layer mounted on a bottom face of the surface layer; and
a bottom layer arranged on a bottom face of the intermediate layer and stuck to the surface layer through the intermediate layer;
wherein:
the surface layer is a sheet plate with a determined length and thickness;
the surface layer has a top face provided with a pattern zone;
the intermediate layer is an adhesive that is applied over the bottom face of the surface layer;
the bottom layer includes:
a film layer attached to the bottom face of the intermediate layer and stuck to the surface layer through an adhesive action of the intermediate layer;
a reusable sticky layer attached to a bottom face of the film layer; and
a release paper attached to a bottom face of the reusable sticky layer;
the film layer is located between the surface layer and the reusable sticky layer;
the film layer is made of transparent material and has a profile corresponding to that of the surface layer;
the reusable sticky layer is configured to be used and stuck repeatedly and has a profile corresponding to that of the film layer;
the release paper is made of transparent material and has a profile corresponding to that of the reusable sticky layer; and
the release paper is removable from the reusable sticky layer.

2. The floor tile structure of claim 1, wherein the floor tile structure has a periphery provided with a plurality of connecting blocks and a plurality of connecting grooves, and the connecting blocks and the connecting grooves are located at a periphery of the surface layer, the intermediate layer and the bottom layer.

3. The floor tile structure of claim 2, wherein the connecting blocks and the connecting grooves present a convex or concave state and are distant equally from each other.

4. The floor tile structure of claim 3, wherein the connecting blocks and the connecting grooves have geometric profiles matching each other.

5. The floor tile structure of claim 1, wherein the pattern zone of the surface layer has a convex or concave shape.

6. The floor tile structure of claim 1, wherein the pattern zone of the surface layer is stuck to or transfer printed on the surface layer.

7. The floor tile structure of claim 1, wherein the adhesive of the intermediate layer is selected from a quick-drying glue, an AB glue or a silicone.

8. The floor tile structure of claim 1, wherein the film layer is made of PET (polyethylene terephthalate).

9. The floor tile structure of claim 1, wherein the reusable sticky layer is made of a PU (polyurethane) glue.

10. A floor tile structure comprising:
a surface layer;
an intermediate layer mounted on a bottom face of the surface layer;
a soft layer arranged on a bottom face of the intermediate layer and stuck to the surface layer; and
a bottom layer arranged on a bottom face of the soft layer and stuck to the surface layer through the intermediate layer;
wherein:
the surface layer is a sheet plate with a determined length and thickness;
the surface layer has a top face provided with a pattern zone;
the intermediate layer is an adhesive that is applied over the bottom face of the surface layer;
the soft layer has ductile and buffering characteristics;
the bottom layer includes:
a film layer attached to the bottom face of the soft layer and stuck to the surface layer through an adhesive action of the intermediate layer;
a reusable sticky layer attached to a bottom face of the film layer; and
a release paper attached to a bottom face of the reusable sticky layer;
the film layer is located between the soft layer and the reusable sticky layer;
the film layer is made of transparent material and has a profile corresponding to that of the surface layer;
the reusable sticky layer is configured to be used and stuck repeatedly and has a profile corresponding to that of the film layer;
the release paper is made of transparent material and has a profile corresponding to that of the reusable sticky layer; and
the release paper is removable from the reusable sticky layer.

11. The floor tile structure of claim 10, wherein the floor tile structure has a periphery provided with a plurality of connecting blocks and a plurality of connecting grooves, and the connecting blocks and the connecting grooves are located at a periphery of the surface layer, the intermediate layer, the soft layer and the bottom layer.

12. The floor tile structure of claim 11, wherein the connecting blocks and the connecting grooves present a convex or concave state and are distant equally from each other.

13. The floor tile structure of claim 12, wherein the connecting blocks and the connecting grooves have geometric profiles matching each other.

14. The floor tile structure of claim 10, wherein the pattern zone of the surface layer has a convex or concave shape.

15. The floor tile structure of claim 10, wherein the pattern zone of the surface layer is stuck to or transfer printed on the surface layer.

16. The floor tile structure of claim 10, wherein the adhesive of the intermediate layer is selected from a quick-drying glue, an AB glue or a silicone.

17. The floor tile structure of claim 10, wherein the soft layer is made of flexible material that is selected from any one of PU, PP (polypropylene) or foamable material.

18. The floor tile structure of claim 10, wherein the film layer is made of PET.

19. The floor tile structure of claim 10, wherein the reusable sticky layer is made of a PU glue.
